(19) United States
(12) Patent Application Publication
(10) Pub. No.: US 2024/0261847 A1
(43) Pub. Date: Aug. 8, 2024

(54) METHOD AND WIRE PROCESSING MACHINE THAT PRODUCES SHAPED PARTS FROM INSULATED FLAT MATERIAL

(71) Applicant: WAFIOS Aktiengesellschaft, Reutlingen (DE)

(72) Inventors: Jörg Niethammer, Ammerbuch (DE); Jörg Möck, Sonnenbühl (DE); Dirk Taigel, Reutlingen (DE)

(73) Assignee: WAFIOS Aktiengesellschaft, Reutlingen (DE)

(21) Appl. No.: 18/435,412

(22) Filed: Feb. 7, 2024

(30) Foreign Application Priority Data
Feb. 8, 2023 (DE) 10 2023 201 030.5

(51) Int. Cl. B21F 11/00; B21F 45/00

(52) U.S. Cl. CPC B21F 11/00; B21F 45/00

(57) ABSTRACT

A method produces straight or bent shaped parts from insulated flat material, and a wire processing machine suitable for carrying out the method has a stripping device for stripping portions of the insulated flat material.

### TECHNICAL FIELD

This disclosure relates to a method of producing straight or bent shaped parts from insulated flat material, and a wire processing machine suitable for carrying out the method having a stripping device for stripping portions of the insulated flat material.

### BACKGROUND

Vehicles with fully or partially electric drives are increasingly being offered on the market. Most of such vehicles have high-capacity energy storage systems with a plurality of battery modules. The electrical energy must be transported between the individual battery modules. To that end, insulated and bent copper or aluminum bars, which are also referred to as “busbars”, are used. Furthermore, the wiring harnesses that run in the longitudinal direction of vehicles between the front and the rear are increasingly being replaced by busbars. Owing to the ever increasing currents, busbars with a correspondingly large current-carrying cross section are required. Because the spaces available for the installation of busbars are sometimes relatively cramped and geometrically complex, busbars that have bends in one or more locations are many times required.

Flat materials in the form of insulated and bent copper or aluminum wires with a rectangular cross section are frequently also used in the production of coil elements for electric motors.

In the production of insulated flat material for a busbar or a coil element, an electrically conducting carrier material (e.g. a flat wire of aluminum or copper) is first coated or sheathed from end to end with an electrically insulating insulation layer. However, the insulation layer is to be removed at the contact points with the electrical connector of the element so that the carrier material is as bare as possible. A working step of “stripping” is carried out for this purpose. Stripping is a process in which part of the insulating sleeve (also “insulation” or “insulation layer”) of an electrical conductor is removed over a specific length required for connection (“stripping length”). For subsequent fastening in the installation environment in question, busbars are then generally either screwed down, clamped or soldered. Coil elements are fastened in a corresponding manner.

WO 2018/134115 A1 describes a method and a system of producing a bent part from insulated flat material. The flat material has a flat electrically conducting carrier material which is sheathed by an electrically insulating insulation layer. The insulated flat material is supplied from a material supply to a bending machine and is shaped in the bending machine into a two-or three-dimensionally bent part of insulated flat material, which is then separated from the supplied insulated flat material in a cutting operation. Before the bent part is separated from the supplied flat material, part of the insulation layer is removed from the electrically conducting carrier material in at least one portion of the insulated flat material in a stripping operation carried out by a stripping device integrated in the bending machine on the flat material guided in the bending machine. The stripping operation is carried out in a continuous process on the flat material passing through the stripping device. In one example, the insulation layer on at least one side face of the flat material is removed by a knife having a straight cutting edge which, in a working position of the knife, is arranged in the vicinity of a side face of the carrier material that is to be exposed such that a part of the insulation layer that is engaged by the knife is removed from the carrier material as the flat material continues to move relative to the knife.

DE 10 2019 213 976 B4 discloses another wire processing machine adapted to produce straight or bent shaped parts from insulated flat material and has an integrated stripping device. The stripping device works with pairs of milling tools that simultaneously engage opposite side faces of the flat material. During a milling operation, the flat material is centered and held relative to the passage axis by clamping elements of a controllable clamping device so that, for stripping, the milling tools travel along the stationary flat material parallel to the passage direction. The distance between the clamping elements is adjustable.

It is also known to use laser radiation for stripping flat material (see e.g. DE 10 2013 006 361 A1 or WO 2019/101394 A1). Laser systems are relatively expensive.

There is nonetheless a need to provide a method and a wire processing machine of the type mentioned in the introduction that can be used inter alia in the manufacture of partially stripped busbars, coil elements or precursors thereof with high productivity and are able to deliver the highest quality in different demands of the stripping, in particular in different stripping lengths. The wire processing machine is to be relatively inexpensive and give rise to relatively low operating costs in operation.

### SUMMARY

We provide a method of producing straight or bent shaped parts from insulated flat material having an electrically conducting carrier material sheathed by an electrically insulating insulation layer, including: a) drawing the insulated flat material from a material supply by a draw-in device and processing in a wire processing machine to form a straight or bent shaped part of insulated flat material; b) separating the shaped part from the supplied insulated flat material in a cutting operation, wherein before the shaped part is separated from the supplied flat material, a portion of the flat material is fixed at a first clamping point on the feed side and at a second clamping point located at a distance therefrom by clamping (in a clamping direction), and in an intermediate region between the clamping points, part of the insulation layer is removed from the electrically conducting carrier material over a stripping length in a stripping operation, the distance between the clamping points is adapted to parameters of the stripping operation, and one of the clamping points remains fixed relative to the machine and only the other clamping point is moved to change the distance between the clamping points.

We also provide a wire processing machine that produces straight or bent shaped parts from insulated flat material, including: a draw-in device that draws the flat material from a material supply and conveys the flat material parallel to a passage axis; a cutting device that separates the shaped part from the supplied insulated flat material; an integrated stripping device that strips portions of the insulated flat material before the shaped part is separated from the supplied flat material, wherein the stripping device has a clamping device having clamping elements that fix the flat material relative to a passage axis during a stripping operation; the clamping device has a first clamping unit on the feed side and a second clamping unit arranged at a distance therefrom, and one of the clamping units is mounted such that it is fixed relative to the machine and only the other clamping unit is movable over a movement path to change the distance between the clamping units.

### BRIEF DESCRIPTION OF THE DRAWINGS

FIG. 1 shows, schematically, a bending machine according to an example.

FIG. 2 shows an oblique perspective view of the stripping device of the example of FIG. 1 including the clamping units.

FIG. 3 shows a plan view of the stripping device of FIGS. 1 and 2.

FIGS. 4A and 4B show different working positions of the movable clamping unit.

FIG. 5 shows an example in which the movable second clamping unit has a clamping element in the form of a rotatably mounted roller.

### DETAILED DESCRIPTION

We provide a method of producing straight or bent shaped parts from insulated flat material having an electrically conducting carrier material sheathed by an electrically insulating insulation layer. The term “flat material” generally denotes workpieces, the carrier material of which has at least two side faces oriented parallel to one another. The thickness of the flat material measured between the side faces can be smaller than the width of the side faces. The carrier material can have, for example, a rectangular cross section with relatively sharp or slightly or fully rounded edges and/or edges provided with a chamfer. However, substantially square cross-sectional forms, optionally with slightly or fully rounded edges and/or edges provided with a chamfer, are also possible.

The insulated flat material is drawn from a material supply by a draw-in device and is processed in a wire processing machine to form a straight or bent shaped part of insulated flat material. The shaped part is then separated from the supplied insulated flat material in a cutting operation. Before the shaped part is separated from the supplied flat material, a portion of the flat material is fixed at a first clamping point on the feed side and at a second clamping point located at a distance therefrom by clamping in a clamping device. In an intermediate region between the clamping points, part of the insulation layer is then removed from the electrically conducting carrier material over a stripping length in a stripping operation. The (axial) distance, measured parallel to the passage axis, between the clamping points is adapted to parameters of the stripping operation. One of the clamping points is fixed relative to the machine and only the other clamping point is moved or displaced to change the distance between the clamping points.

A wire processing machine adapted to carry out the method has, in addition to the draw-in device and the cutting device, an integrated stripping device for stripping portions of the insulated flat material before the shaped part is separated from the supplied flat material. The stripping device comprises a clamping device having clamping elements for fixing the flat material relative to a passage axis during a stripping operation. The clamping device has a first clamping unit on the feed side and a second clamping unit arranged at a distance therefrom. One of the clamping units is mounted such that it is fixed relative to the machine, and only the other clamping unit is movable over a travel path to change the distance between the clamping units.

Because one of the clamping units is mounted such that it is fixed relative to the machine, the axial position, that is to say the position along the passage axis, for that clamping unit is predefined and can thus very easily be taken into consideration when controlling the process. Moreover, the fact that only one of the clamping units is designed to be movable in translation results in a simplification of the construction so that the wire processing machine can be provided less expensively and more robustly compared to conventional wire processing machines having two adjustable clamping units.

The movable clamping unit can be adjusted manually during set-up of the machine so that the movable clamping unit does not require its own actuating drive. This results in an inexpensive, robust construction. Preferably, the movable clamping unit has its own associated machine axis so that the movable clamping unit is able to be moved to the desired position by an actuating drive in response to control signals of a control unit. Collisions between the clamping unit and other components of the stripping device can thus systematically be avoided, because the controller knows the axial position of the movable clamping unit at all times. Moreover, changes in the distance are also possible during operation.

Preferably, the first clamping unit arranged on the feed side is mounted such that it is fixed relative to the machine, and the second clamping unit located further back in the passage direction is movable. It is thus particularly easy to precisely set the distance between the clamping units for different stripping lengths or different stripping operations. Large working ranges can also be achieved relatively easily. The “working range” denotes the available range from the minimum to the maximum achievable stripping length. The working range can be, for example, 0 mm to 120 mm or more.

Clamping of the flat material to fix the portion located between the clamping points for the stripping operation can be useful in various stripping techniques, for example, also in contactless stripping techniques such as, for example, in stripping by laser radiation. Particularly great advantages are achievable when the insulation layer is mechanically removed in the stripping operation predominantly or exclusively by the action of at least one mechanical stripping tool, for example, by scraping, skinning, milling, grinding or the like. By clamping the material on both sides, it is possible to prevent the machining forces acting on the flat material from deflecting the flat material transverse to the passage direction such that the precision of the stripping is impaired. By clamping on both sides, the portion to be stripped is readily able to withstand the machining forces.

In preferred examples, the stripping operation comprises a milling operation carried out by a milling device of the wire processing machine. During the milling operation, two milling tools having peripheral cutting edges or end cutting edges and are rotatable about axially parallel rotational axes on opposite side faces of the flat material are fed in the direction towards the side faces into a working position in which peripheral cutting edges are in engagement with the insulation layer, and the milling tools are moved parallel to the passage axis relative to the flat material fixed by clamping. We found that particularly good stripping results can thus be achieved, wherein the insulation material can be removed substantially completely without the metallic carrier material being damaged. In alternative examples, scraping knives or rotary knives can also be used for the mechanical stripping.

The axial position of the second clamping point may be controlled automatically such that a shortest possible distance between the clamping points is set for each stripping operation. A shortest possible clamped length has an advantageous effect on the stability of the intermediate portion against machining forces acting in the transverse direction.

In some method examples, at least one stripping tool is fed during the stripping operation in the region between the clamping points and moved from the first clamping point in the direction towards the second clamping point, wherein the second clamping point is preferably displaced synchronously with the movement of the stripping tool with enlargement of the distance from the first clamping point. Thus, approximately the shortest clamped length can be achieved at all times during a stripping operation. The stripping tool then at all times engages the flat material in the vicinity of the second clamping point so that the flat material is scarcely able to move out of the way even of relatively high machining forces.

In examples designed such that the movable clamping unit moves during the stripping operation, that is to say while the material is to be clamped, the component of a clamping unit that is in contact with the workpiece, that is to say the clamping element, is preferably configured as a clamping element that is capable of rolling, for example, in the form of a, for example, cylindrical roller or a pressing belt guided via two or more rollers.

Particularly good stripping results may be systematically achieved if, before a stripping operation, the flat material is first centered in a transverse direction relative to the passage axis and then the centered flat material is clamped in a clamping direction oriented perpendicular to the transverse direction. In this example, the functions of centering and of clamping are thus separated from one another functionally and in terms of time.

Structurally, this can be achieved in that each of the clamping units has an associated separately controllable centering unit for centering the flat material prior to clamping. Preferably, each of the centering units has a centering assembly group having two centering arms, optionally guided in a common guide, which are movable by a drive which is controllable by the control device between a centering configuration and an open configuration. There is preferably used a pneumatic drive, which provides a certain flexibility so that the flat material is centered in a gentle manner but is not clamped with a relatively great clamping force between the centering arms.

We provide in the wire processing machine that each of the clamping units may have a clamping assembly group having two clamping jaws which are movable by a drive between a clamping configuration and an open configuration, wherein each of the clamping jaws has an extension arm which projects from outside in the direction of the passage axis and which has at its free end a clamping element having a contact face configured to press against a side face of the flat material. The clamping element can be, for example, a clamping shoe, which has a substantially planar contact face for application to the broad side of the flat material. As a result of the configuration with an extension arm, a sufficiently large distance can be provided between the flat material to be clamped and the components of the clamping unit that carry the clamping jaws having the extension arm. In particular relatively short distances between the clamping points can thus also be set.

A particularly compact arrangement can be achieved in that the clamping assembly groups of the clamping units are each arranged obliquely relative to the passage axis such that the extension arm moves in a clamping plane which is oblique relative to the passage direction and to an orthogonal plane oriented perpendicular to the passage direction. In particular, the clamping plane can be set at an angle of 45° to the passage direction. As a result, sufficient installation space can be provided on each side of the flat material to accommodate other components of the stripping device, for example, to accommodate drives and carriages for movable milling units.

Each of the clamping shoes may have a rectangular contact face configured to press against the workpiece surface, the contact face having side edges which are directed parallel and perpendicular to the passage axis and are oriented obliquely relative to a longitudinal direction of the extension arm, in particular at an angle of 45°. As a result, it can be achieved that the clamping element can be pressed onto the flat material over a large area and thus without the risk of deformation, and an oblique position of the clamping plane relative to the passage axis is nevertheless possible.

In preferred examples, a symmetrical arrangement of the clamping units is provided in that the clamping planes of the clamping assembly groups are oriented parallel to one another.

Considerable cost savings can be achieved in one example in that the clamping assembly groups of the clamping units are substantially identical in terms of construction. This means that they are composed substantially of carry-over parts which are to be found identically in both clamping units. Manufacture is thus simplified and comparatively inexpensive.

Further advantages and aspects of our methods and machines will become apparent from the description of examples that are explained hereinbelow with reference to the figures.

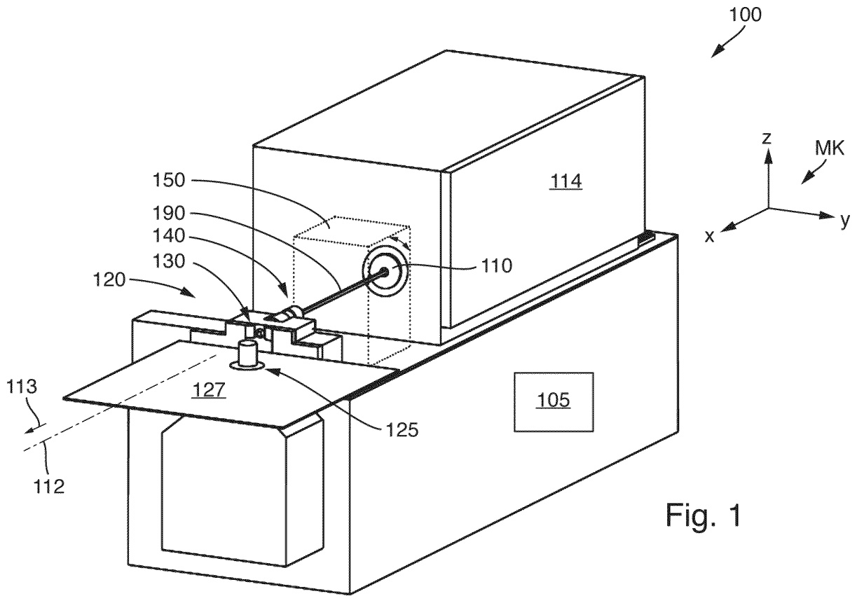

FIG. 1 shows an example of a wire processing machine 100 in the form of a bending machine for producing two-dimensionally or three-dimensionally bent shaped parts, or bent parts, from insulated flat material 190. The bending machine has an orthogonal machine coordinate system MK, identified by lowercase letters x, y and z, having a vertical z-axis and horizontal x-and y-axes. In the example shown, the x-axis runs parallel to a draw-in direction in which the flat material to be bent is supplied by a draw-in device 110 to a downstream bending device 120. The machine axes, driven in a controlled manner, which are denoted by uppercase letters (for example, A-axis, Z-axis and the like) and will be mentioned hereinbelow are to be distinguished from the coordinate axes of the machine coordinate system. A control unit 105 of the bending machine controls and coordinates the working movements of all the machine axes.

The starting material to be shaped, namely insulated flat material 190, is drawn through the bending machine in a passage direction 113 along a passage axis 112 by the draw-in device 110. The draw-in device serves to supply the flat material from a material supply. The feed force in the draw-in direction (parallel to the x-direction) is generated by friction between draw-in elements of the draw-in device and the flat material. The draw-in device can be configured, for example, as a roller draw-in, belt draw-in or gripper draw-in. Before the starting material (insulated flat material in the example) enters the draw-in device 110, the flat material passes through an alignment unit which, in the example, has a number of rollers arranged in an offset manner and is concealed beneath a protective cover 114.

For many bent parts, bends in different bending planes which are at an angle to one another are required so that the resulting bent parts are bent three-dimensionally. To make this possible without a complex construction of the bending device, the draw-in device 110 is rotatable about the passage axis in both rotational directions. As a result, it is possible in a simple manner to make a change between bending planes between individual bending operations. In the example, the draw-in device 110 and the upstream alignment device are rotated by a servomotor about a corresponding machine axis (A-axis). The draw-in device is guided on guide rails running parallel to the x-direction and is axially displaceable parallel to the x-direction by a displacement drive (V-axis).

To produce bends in the flat material 190 by shaping, a numerically controlled bending device 120 is provided. In the bending region, the flat material is bent into the desired shape by a CNC-controlled bending head 125 of the bending device. The bending head has two shafts which are rotatable independently of one another, namely a mandrel shaft and a hollow shaft. On the mandrel shaft there are bending mandrels. The bending head can be equipped with different tools according to the machining requirement. Large bent parts can be supported by a retrofittable support table 127. The components of the bending device 120 are able to move out of the way in a change of the bending plane in the bending head axis direction (Z-axis) perpendicular to the x-direction and can then engage into the flat material again after the bending plane has been changed.

Between the bending region having the bending head 125 of the bending device 120 and the draw-in device 110 there is mounted a cutting device 130 which is provided to separate the finished bent part from the supplied flat material (when all the bending operations and optionally one or more twisting operations are complete). The cutting device 130 of the bending machine is designed as a bite-action cutting device, that is to say is configured such that the bent part is separated from the supplied flat material by the process of “bite-action cutting”.

The bending machine 100 has an optional integrated twisting device 140 which is configured to produce an irreversible deformation in at least one portion of the flat material by a twisting operation by torsion of the flat material before the bent part is separated from the supplied flat material. All the components of the twisting device 140 that are provided for engagement with the flat material are arranged in the region between the exit of the draw-in device 110 and the bending head 125 of the bending unit 120.

The structure and function of the components of the bending machine which have been described hitherto can correspond to those of the bending machine described in DE 10 2018 209 889 A1. In this respect, the disclosure thereof is included in the content of the description by reference.

Using the bending machine 100 it is possible to manufacture inter alia two-dimensionally or three-dimensionally bent busbars, as are required inter alia in the automotive sector for transporting electrical energy between vehicle assembly groups or within battery groups. The starting material is an insulated flat material 190, which consists substantially of an electrically conducting, metallic carrier material, an adhesion promoter on the surface of the carrier material, and an electrically insulating insulation layer on the adhesion promoter. The carrier material generally has a flat cross section with plane-parallel broad sides and narrow sides which connect the broad sides and can have a more or less pronounced curvature or can be substantially planar. Frequently, the cross section is approximately rectangular with more or less extensive rounded corners. The flat material can also have a substantially square cross section. The insulation layer generally sheathes the carrier material completely. The insulation layer is frequently manufactured from specific polyamide plastics materials. The carrier material in most examples consists of copper (Cu) or aluminum (Al) or of Cu-or Al-based alloys and is responsible for conducting the current.

The width of the flat material (measured in the width direction perpendicular to the longitudinal direction) can be a multiple of the thickness (measured at the narrow sides), for example, from three times to seven times. Widths can be of the order of magnitude of several millimeters, for example. The insulation layer usually has a thickness of less than 1 mm.

The bending machine 100 is designed to remove part of the insulation layer from the electrically conducting carrier material in at least one portion of the insulated flat material in a stripping operation before the shaped part is separated from the supplied flat material. For this purpose, a stripping device 150 is integrated in the bending machine. The components of the stripping device that are close to the workpiece are arranged, when seen in the passage direction, between the draw-in device 110 and the cutting device 130.

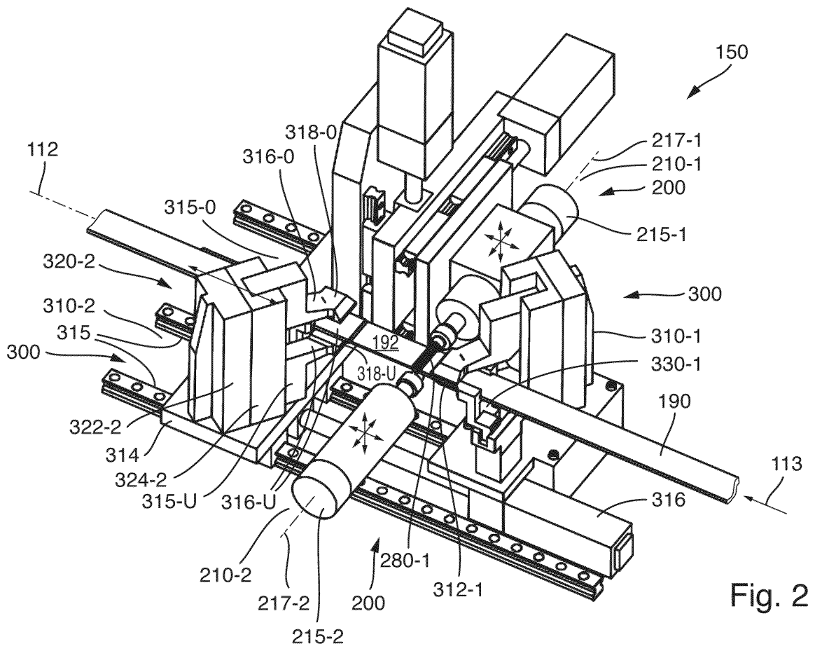

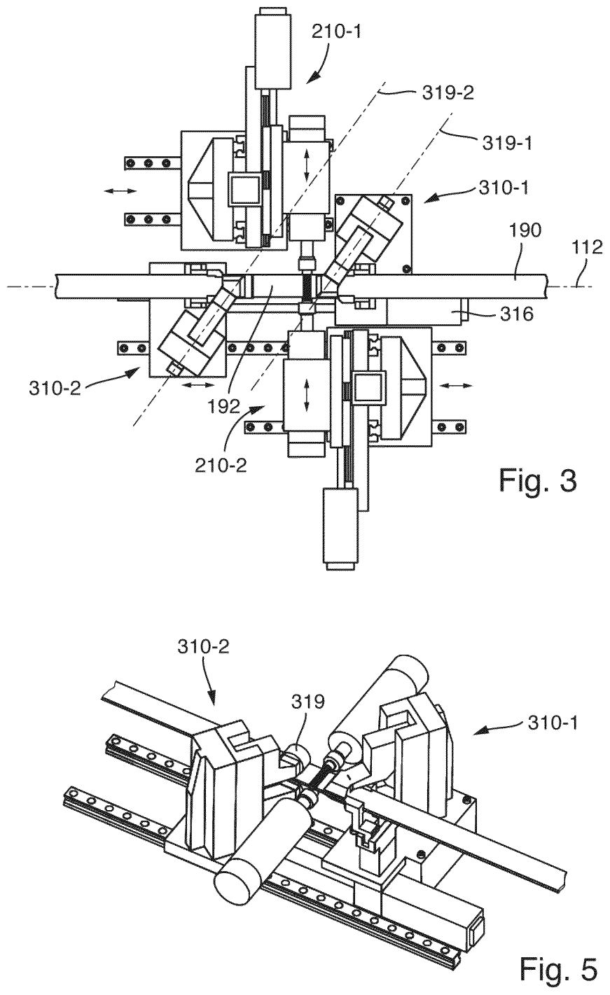

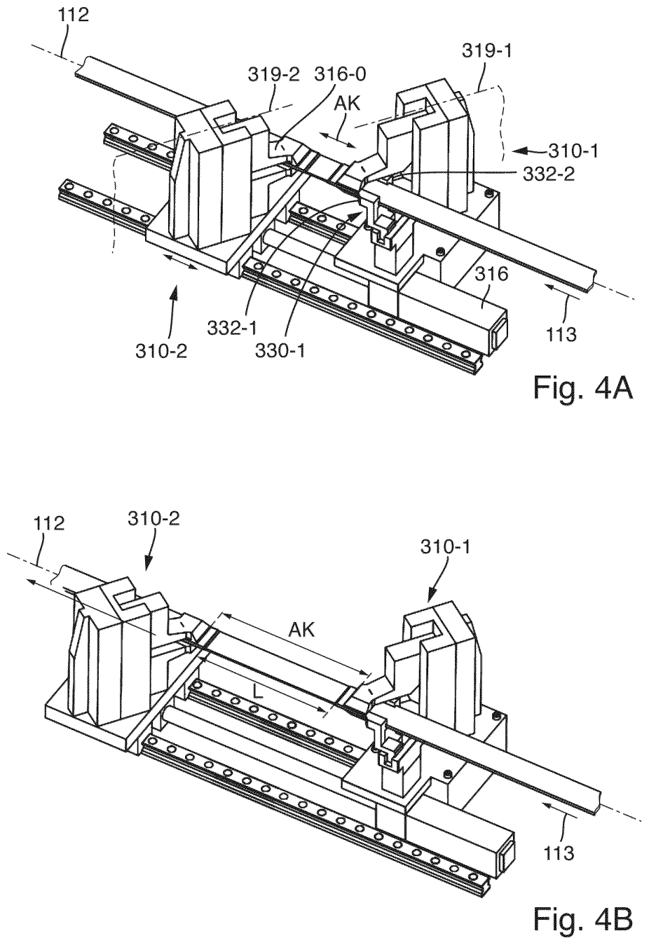

The construction and functioning of the stripping device 150 of the example will now be explained in detail with reference to FIG. 2 ff. FIG. 2 shows an oblique perspective view of a milling device 200 and an associated clamping device 300 of the stripping device 150, FIG. 3 shows a plan view from above, FIGS. 4A and 4B show different working positions of the components, and FIG. 5 shows another example.

The milling device 200 has two milling units (first milling unit 210-1, second milling unit 210-2), the milling spindles of which (first milling spindle 215-1, second milling spindle 215-2) are arranged axially parallel and axially offset relative to one another so that the rotational axes 217-1, 217-2 of the milling spindles are parallel and offset relative to one another and the milling tools (see first milling tool 280-1) received in the milling spindles can be rotated about rotational axes which are parallel and offset relative to one another (coaxial with the rotational axes 217-1, 217-2 of the milling spindles).

The two milling spindles 210-1, 210-2 are movable in a controlled manner by their own machine axes in three directions which are alternately orthogonal to one another (displacement parallel to the passage axis, displacement parallel to the rotational axis of the milling tool, and displacement perpendicular to the rotational axis). Inter alia, the described components of the milling device 200 can jointly be advanced or moved in translation parallel to the passage axis 112 by coordination of the machine axes acting in the x-direction.

The stripping device 150 includes as a functional component a clamping device 300 which, for carrying out a stripping operation, is adapted to fix the flat material, in the axial direction in front of and behind the portion 192 to be stripped, by clamping such that the flat material is stationary during stripping and in practice cannot evade the machining forces. The clamping device comprises a first clamping unit 310-1 which, when seen in the passage direction 113, engages the flat material at a first clamping point 312-1 before the working region of the milling device 200, and a second clamping device 310-2 which engages the flat material at a second clamping point 312-2 after the working region of the milling device in the passage direction. The first clamping unit is fixedly mounted on the machine frame at a predefined position so that the axial location of the first clamping point 312-2 is fixed in respect of the machine coordinate system.

By contrast, the axial position of the second clamping point 312-2 is infinitely variably adjustable in response to control signals of the control unit 105. To that end, the components of the second clamping unit 310-2 are mounted on a carriage 314 which can be moved parallel to the passage axis 112 on two guide rails 315 which run parallel to the passage axis. A servomotor 316 is provided as the actuating drive, the servomotor being mounted between the guide rails and driving a threaded spindle which runs between the guide rails and on which there runs a threaded nut which is mounted on the underside of the carriage 314. By activating the actuating drive 316, the axial distance AK between the clamping points 312-1, 312-2 can be infinitely adjusted at a time before a stripping operation or also during a stripping operation.

The clamping units 310-1, 310-2 are constructed substantially identically using carry-over parts. The construction will be explained in detail with reference to the second clamping unit 310-2. The second clamping unit has a second clamping assembly group 320-2 which has a vertical support 322-2 which is mounted on the carriage plate and which supports on its side facing the workpiece, or the passage axis 112, a solid guide element 324-2 having a guide groove running in the z-direction. An upper clamping jaw 315-O and a lower clamping jaw 315-U are guided in the guide groove to be displaceable in opposite directions. The associated electromechanical actuating drive can move the clamping jaws between an open configuration shown in FIG. 2 and a clamping configuration in which they are in clamping engagement with the flat material 190.

Each of the clamping jaws has a base portion which runs in the guide groove and from which a horizontal extension arm 316-O or 316-U projects in the direction of the passage axis. Clamping elements in the form of enlarged clamping shoes 318-O and 318-U are formed at the free ends of the extension arms, the clamping shoes each having on their side facing the workpiece, or the passage axis, a planar contact face for pressing on the upper side or lower side, respectively, of the flat material 190 over a large area. The horizontal longitudinal direction of the extension arm and the vertical direction of the guide of the clamping jaws span a clamping plane 319-2 which runs at an angle of 45° to the passage axis 112 or to the side edges of the clamping shoe that run parallel to the passage axis.

The first clamping unit 310-1 has a corresponding construction with a corresponding oblique orientation of its clamping plane 319-1. The clamping planes are set at 45° to the passage axis 112, or to the passage direction, and run parallel to one another. This oblique position offers multiple advantages. First, there is sufficient space next to each of the oblique clamping assembly groups for the components of the milling units which are displaceable parallel to the passage axis. Second, the clamping units can be moved sufficiently far towards one another, without the clamping assembly groups colliding, that the axial distance AK between the clamping points can be reduced to almost 0 with the milling units retracted so that very short clamping lengths can be set.

The clamping units are designed to clamp the flat material solely in the vertical clamping direction. They do not have a centering function in the transverse direction (y-direction). Nevertheless, to center the flat material exactly relative to the passage axis 112, each of the clamping units has an associated separately controllable centering unit. In FIG. 2, the front centering unit 330-1 can be seen particularly clearly. Its components are mounted on the base plate, which also carries the clamping assembly group. The centering assembly group has two centering arms 332-1, 332-2 which are guided in a horizontal guide running perpendicular to the passage axis and can be moved by a pneumatic drive in the direction towards one another or away from one another between a centering configuration, in which they engage at the same time with the narrow edges of the flat material, and an open configuration. In a preparation phase for a stripping operation, the centering unit is first activated to center the flat material in the transverse direction (y-direction), before the clamping unit is then activated to clamp the centered flat material in the vertical clamping direction (z-direction). The stripping operation then begins.

In all the method examples, it is possible, owing to the adjustability of the axial position of the second clamping unit 310-2, to adapt the distance AK between the clamping points to the length of the region to be stripped, that is to say to the stripping length L. In this connection, FIG. 4A shows, by way of example, a relatively small stripping length, and FIG. 4B shows a larger stripping length L, which can be set by correspondingly moving the second clamping unit 310-2 to a greater distance AK from the first clamping unit 310-1 which is mounted such that it is fixed relative to the machine. The stripping operation can then begin once this distance has been set and the flat material has been clamped. Generally, AK>L, that is to say the free length between the clamping points is greater than the stripping length. The difference L−AK can remain substantially the same independently of the length L.

Another example will be described with reference to FIG. 5. In that figure, the first clamping unit 310-1 on the feed side has the same construction as in the first example. In the movable second clamping unit 310-2, in contrast to the first example, a clamping element in the form of a pressing roller 319 mounted with a horizontal rotational axis is mounted at the free end of each of the extension arms. The stripping operation here proceeds such that the flat material 190 is first clamped at the two clamping points in front of and behind the region to be stripped, and the milling units are brought into engagement with the flat material. The clamped length, that is to say the distance AK, between the clamping points is initially relatively short. The milling units then move slowly in the direction towards the second clamping unit 310-2 and move away from the first clamping point 312-1. At the same time and at the same speed, the second clamping unit 310-2 is slowly advanced to increase the distance from the first clamping unit. During this process, the flat material remains clamped between the pressing rollers rotating in opposite directions. The two movements can be synchronized such that the distance between the second clamping point (where the rollers are pressed onto the flat material) and the engagement position of the milling cutters substantially does not change so that the milling cutters always engage relatively close to the second clamping point, whereby vertical displacement of the flat material is largely prevented.

We found that the distance between the clamping points has a substantial influence on the milling result. In the examples, the clamping means on the feed side is fixed, whereas the rear clamping means can be moved by a servomotor. The shortest possible clamping distance can be reached automatically. A collision between the milling cutter and the clamping device is prevented because the controller knows the position of the clamping points. The movable clamping point can if required be moved parallel to the forward feed during the milling operation.

What is claimed is:

1. A method of producing straight or bent shaped parts from insulated flat material having an electrically conducting carrier material sheathed by an electrically insulating insulation layer, comprising:
a) drawing the insulated flat material from a material supply by a draw-in device and processing in a wire processing machine to form a straight or bent shaped part of insulated flat material,
b) separating the shaped part from the supplied insulated flat material in a cutting operation, wherein
before the shaped part is separated from the supplied flat material, a portion of the flat material is fixed at a first clamping point on the feed side and at a second clamping point located at a distance therefrom by clamping (in a clamping direction), and in an intermediate region between the clamping points, part of the insulation layer is removed from the electrically conducting carrier material over a stripping length in a stripping operation,
the distance between the clamping points is adapted to parameters of the stripping operation, and
one of the clamping points remains fixed relative to the machine and only the other clamping point is moved to change the distance between the clamping points.

2. The method according to claim 1, further comprising automatic control of the (axial) position of the second clamping point such that a minimum distance between the clamping points is set for each stripping operation.

3. The method according to claim 1, wherein the first clamping point remains static and only the second clamping point is displaced in dependence on the stripping length.

4. The method according to claim 1, wherein the insulation layer is mechanically removed in the stripping operation predominantly or solely by the action of at least one mechanical stripping tool, and the stripping operation comprises a milling operation.

5. The method according to claim 1, wherein, during a stripping operation, at least one stripping tool is moved from the first clamping point in the direction towards the second clamping point, and the second clamping point is displaced synchronously with the movement of the stripping tool with enlargement of the distance from the first clamping point.

6. The method according to claim 1, wherein, before a stripping operation, the flat material is first centered in a transverse direction relative to a passage axis and then the centered flat material is clamped in a clamping direction oriented perpendicular to the transverse direction.

7. A wire processing machine that produces straight or bent shaped parts from insulated flat material, comprising:
a draw-in device that draws the flat material from a material supply and conveys the flat material parallel to a passage axis;
a cutting device that separates the shaped part from the supplied insulated flat material;
an integrated stripping device that strips portions of the insulated flat material before the shaped part is separated from the supplied flat material, wherein the stripping device has a clamping device having clamping elements that fix the flat material relative to a passage axis during a stripping operation;
the clamping device has a first clamping unit on the feed side and a second clamping unit arranged at a distance therefrom, and
one of the clamping units is mounted such that it is fixed relative to the machine and only the other clamping unit is movable over a movement path to change the distance between the clamping units.

8. The wire processing machine according to claim 7, wherein the movable clamping unit has its own associated machine axis such that the movable clamping unit is movable by an actuating drive in response to control signals of a control unit.

9. The wire processing machine according to claim 7, wherein the first clamping unit is mounted such that it is fixed relative to the machine and the second clamping unit is movable.

10. The wire processing machine according to claim 7, wherein each of the clamping units has a clamping assembly group having two clamping jaws movable by a drive between a clamping configuration and an open configuration, and each of the clamping jaws has an extension arm that projects in the direction of the passage axis and has at its free end a clamping element having a contact face configured to press against a side face of the flat material.

11. The wire processing machine according to claim 10, wherein the clamping assembly groups of the clamping units are each arranged obliquely to the passage axis such that the extension arm moves in a clamping plane oblique relative to the passage axis and to an orthogonal plane oriented perpendicular to the passage axis or at an angle of 45° to the passage axis, and the clamping planes of the clamping assembly groups are oriented parallel to one another.

12. The wire processing machine according to claim 10, wherein some or all of the clamping elements have a rectangular contact face configured to press against a side face of the flat material and having side edges oriented parallel and perpendicular to the passage axis and oriented obliquely or at an angle of 45°, relative to a longitudinal direction of the extension arm.

13. The wire processing machine according to claim 10, wherein the second clamping unit has at the ends of extension arms clamping elements capable of rolling or in the form of a rotatably mounted roller.

14. The wire processing machine according to claim 10, wherein the clamping assembly groups of the clamping units are identical in terms of construction.

15. The wire processing machine according to claim 7, wherein each of the clamping units has an associated separately controllable centering unit that centers the flat material prior to clamping.

16. The wire processing machine according to claim 15, wherein each of the centering units has a centering assembly group having two centering arms guided in a common guide and movable by a pneumatic drive between a centering configuration and an open configuration.
